(19) United States
(12) Patent Application Publication
(10) Pub. No.: US 2021/0205898 A1
(43) Pub. Date: Jul. 8, 2021

(54) Portable Power Drill With Pump

(71) Applicant: APEX BRANDS, INC., Apex, NC (US)

(72) Inventors: John Fiumefreddo, Apex, NC (US); Rolf Reitz De Swardt, Blythewood, SC (US); Jeremy Watford, irmo, SC (US)

(21) Appl. No.: 17/055,689

(22) PCT Filed: Jul. 18, 2019
(86) PCT No.: PCT/US2019/042378

§ 371 Date: Nov. 16, 2020

Related U.S. Application Data
(60) Provisional application No. 62/700,114, filed on Jul. 18, 2018.

(51) Int. Cl. B23B 47/34; B23B 45/02

(52) U.S. Cl. CPC B23B 47/34; B23B 2250/12; B23B 45/02

(57) ABSTRACT

An example cordless portable power drill is provided. The drill may include a drill chassis, and a spindle mounted to the drill chassis. The spindle may be configured to drive a working bit. The drill may also include an exit port configured to direct a flow of a substance towards the working bit and an electric motor mounted to the drill chassis and operably configured to rotate the spindle. The drill may also include a pump mounted to the drill chassis. The pump may be fluidly coupled to the exit port, and the pump may be configured to pressurize the substance for output via the exit port to cool the working bit or remove debris created by the working bit through interaction with a workpiece.

### CROSS REFERENCE TO RELATED APPLICATION

This application claims priority to U.S. application No. 62/700,114 filed Jul. 18, 2018, the entire contents of which are hereby incorporated by reference in its entirety.

### TECHNICAL FIELD

Example embodiments generally relate to power tools, and in particular relate to power drills.

### BACKGROUND

Current pneumatic and electric positive feed drills (PFDs) also known as Advanced Drilling Equipment (ADE) often require the drill to be attached to an external compressed air supply hose or tube. Some ADE systems require a floor standing lubrication system that the drill is connected to via a hose and other tethered connections. The lubrication system can lubricate and cool the working bit and blow out drill chips formed by the drill while cutting a hole in a workpiece. A disadvantage of these conventional systems is that there needs to be a shop air supply in the vicinity of the application and the drill must be connected to a hose. Requiring a connection to a hose can be particularly problematic in situations where, for example, the operator needs to climb into a small space, such as inside the wing of an airplane under construction, creating a risk that the hose may get snagged or otherwise hinder the operator due to the limited mobility introduced by the necessity to connect the drill to a hose.

### BRIEF SUMMARY OF SOME EXAMPLES

According to some example embodiments, an example cordless portable power drill is provided. The example drill may comprise a drill chassis and a spindle mounted to the drill chassis. The spindle may be configured to drive a working bit. The example drill may further comprise an exit port configured to direct a flow of a substance towards the working bit. The example drill may further comprise an electric motor mounted to the drill chassis and operably configured to rotate the spindle. The example drill may further comprise a pump mounted to the drill chassis. The pump may be fluidly coupled to the exit port. The pump may be configured to pressurize the substance for output via the exit port to cool or lubricate the working bit or remove debris created by the working bit through interaction with a workpiece.

According to some example embodiments, another example cordless portable power drill is provided. The example drill may comprise a drill chassis and a spindle mounted to the drill chassis. The spindle may be configured to drive a working bit. The example drill may further comprise an electric motor mounted to the drill chassis and operably configured to rotate the spindle, and a battery configured to power the electric motor. The example drill may further comprise an air compressor mounted to the drill chassis. The air compressor may be powered by the battery. Further, the example drill may further comprise a storage tank fluidly coupled to the air compressor and an exit port. The storage tank may be configured to retain air in a pressurized state. Further, the air compressor may be configured to pressurize air into the storage tank for controlled output via the exit port to cool or lubricate the working bit or remove debris created by the working bit through interaction with a workpiece.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of an example drill in accordance with an example embodiment;

FIG. 2 illustrates another example drill in accordance with an example embodiment;

FIG. 3 illustrates a front view of a spindle of the drill of FIG. 2 in accordance with an example embodiment; and

FIG. 4 illustrates a flow chart of operations that may be performed by control circuitry of an example drill in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability, or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

According to some example embodiments, a cordless, portable power drill is provided that may be configured to cool and lubricate a working bit of the drill, and also remove debris formed in the drilling process, without the need to connect the drill to an air hose or other tether that would limit mobility of the drill in a working environment. In this regard, according to some example embodiments, the components that are used to perform the cooling, lubrication, or debris removal may be mounted on a chassis of the drill and therefore, according to some example embodiments, the drill may be completely self-contained. As such, in the case of battery operated drills, the drill may be physically de-tethered from any remote objects to offer complete mobility while also supporting these additional functionalities. To do so, the components that support cooling, lubrication, and debris removal may be mounted, for example, directly on a chassis of the drill, possibly, internal to the drill housing.

In this regard, according to some example embodiments, an example portable drill may include a drill chassis to which various components may be mounted. For example, a spindle configured to drive a working bit may be rotatably mounted on or to the drill chassis. Together with the spindle, an electric motor and a pump may also be mounted to the drill chassis. The electric motor may be configured to drive the spindle to turn the working bit of the drill. The pump may be configured to, possibly via mechanical coupling to the electric motor, pressurize a substance (e.g., air) for output via an exit port on or near the spindle to cool or lubricate the working bit, or remove debris created by the working bit through interaction with a workpiece. According to some example embodiments, a storage tank may also be mounted on the drill chassis, such that the storage tank is portable with the drill. The storage tank may be fluidly coupled to the pump to store the substance in a pressurized form to be expelled from the drill, in a controlled fashion, via the exit port.

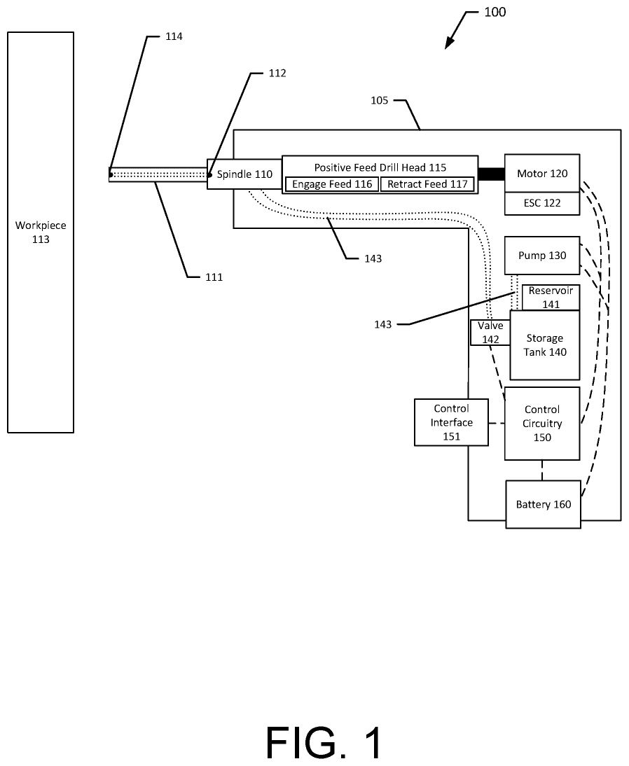

FIG. 1 illustrates an example drill 100 in accordance with some example embodiments. In this regard, the drill 100 may be a cordless power drill. The drill 100 may include a drill chassis 105, a spindle 110, a motor 120, and a pump 130. According to some example embodiments, the drill 100 may further include control circuitry 150.

The drill chassis 105 may be a skeletal structure of the drill 100 that operates to physically support the various components of the drill 100. The drill chassis 105 may be formed of metal, plastic, or the like and may be rigid to provide a general shape of the drill 100. The drill chassis 105 may, at least in some portions of the drill 100, be disposed internal to a drill housing. In this regard, the drill chassis 105 may be integrated with the housing and may therefore be an internal reinforced member upon which the various components may be mounted.

The spindle 110 of the drill 100 may be a rotatable member that is configured to engage and hold a working bit 111 to drive the working bit 111 during operation of the drill 100. The spindle 110 may therefore be operably coupled to the drill chassis 105 such that the spindle 110 may rotate relative to drill chassis 105 and turn the working bit 111. To facilitate rotation, the spindle 110 may have a gear or gearing on a rearward end that directly or indirectly engages with motor 120 to drive the spindle 110. On a forward end, the spindle 110 may include a bore and adjustable jaws or keying (e.g., a keyed protrusion within the bore) that facilitates operable coupling with a working bit 111. In this regard, the spindle 110 may be configured to receive and hold (e.g., tighten onto or lock onto) a variety of working bits 111 that may, for example, perform different functions or be different sizes. For example, the working bit 111 may be a drill bit that is designed to cut a hole in a workpiece 113 via rotation of the drill bit.

The spindle 110 may also include an exit port 112. The exit port 112 may be an external opening that is fluidly coupled, indirectly or directly, to the pump 130. The exit port 112 may be configured to direct a flow of a substance (e.g., compressed air or an air and lubricant mixture) towards or through the working bit 111. In this regard, according to some example embodiments, the working bit 111 may include a channel or tunnel through which the substance may be forced from the exit port 112 of the spindle 110 to the working bit exit port 114 disposed on the forward end of the working bit 111. As further described below, the exit port 112 may be positioned to deliver the substance from the pump 130 to cause the working bit 111 to be cooled or lubricated, and to blow away debris (e.g., drill hole chips). The exit port 112 may be included on a rotating fitting of the spindle 110 to facilitate rotatable coupling.

As indicated above, the drill 100 may also include a motor 120 that is mounted on the drill chassis 105 and configured to convert electrical energy into rotational movement to drive the spindle 110. In this regard, the motor 120 may be a brushless electrical motor that is configured to deliver high torque to the spindle 110 at high speeds. According to some example embodiments, the drill 100 may include an adjustable torque limiter that mechanically interrupts the motor 120's ability to turn the spindle 110 after an adjustable threshold torque is reached. The motor 120 may be a single speed, dual speed, or variable speed motor. In this regard, the motor 120 may include an electronic speed control unit 122 that is controlled, for example, by the control circuitry 150. As such, the speed and other parameters of the operation of the motor 120 may be controlled by the control circuitry 150.

According to some example embodiments, the drill 100 may include a positive feed drill head 115 that is mounted on the drill chassis 105. Via the positive feed drill head 115, the drill 100 may be configured to cause the spindle 110 to translate towards or away from a workpiece 113 during operation of the drill 100. As such, according to some example embodiments, the spindle 110 may be configured to cause the working bit 111 to cut a hole of a specifically desired depth in a workpiece 113 due to the translational movement of the spindle 110 and operation of the positive feed drill head 115. In this regard, the positive feed drill head 115 may mechanically couple the spindle 110 to the motor 120. The positive feed drill head 115 may include a series of reduction gears, possibly disposed in a reduction gearbox, configured to cause translational movement of the spindle 110 and therefore the working bit 111. The positive feed drill head 115 may include a differential feed gearbox that may house the feed components of the positive feed drill head 115. In this regard, the positive feed drill head 115 may include gearing for an engage feed mechanism 116 that operates to translate the spindle 110 toward the workpiece 113 during a cutting operation. The positive feed drill head 115 may also include gearing for a retract feed mechanism 117 that operates to translate the spindle 110 away from the workpiece 113 after a cutting operation is complete to remove the working bit 111 from the newly cut hole in the workpiece 113.

As shown in FIG. 1, the drill 100 may also include a pump 130 that is mounted to the drill chassis 105. In this regard, the pump 130 may be configured to displace (e.g., pressurize) a substance (e.g., a fluid or a gas, such as air) for output via the exit port 112 to cool or lubricate the working bit 111 or remove debris created by the working bit 111 due to interaction with a workpiece 113. As such, the pump 130 may be fluidly coupled to the exit port 112. The pump 130 may be, for example, a compressor (e.g., an air compressor) or a piezoelectric pump. The pump 130 may include an internal electric motor that rotates to cause the pump 130 to operate to displace the substance, or the pump 130 may be operably coupled to the motor 120 (e.g., mechanically coupled) in such a way that permits the pump 130 to leverage the rotational output of the motor 120 to cause the displacement of the substance. According to some example embodiments, the pump 130 may be used to directly force the substance out the exit port 112 (e.g., without the need for storage tank 140).

According to some example embodiments, the drill 100 may further include a storage tank 140 that is fluidly coupled to the pump 130 and the exit port 112 via, for example, tubing, such as, tubing 143. The storage tank 140 may be configured to maintain a substance (e.g., air) in a pressurized state for controlled release. In this regard, via the fluid coupling with the pump 130, a substance may be forced into the storage tank 140 to be maintained in a pressurized state until release of the substance is desired. According to some example embodiments, the storage tank 140 may be mounted to the drill chassis 105 and may take the general shape of a cylinder. In this regard, the storage tank 140 may be a compact, high pressure vessel for storing a pressurized substance, such as, for example, air. According to some example embodiments, the storage tank 140 may include an input valve (e.g., one-way valve, not shown) that is configured to interface with the pump 130 to permit at least a portion of a substance to be forced into the storage tank 140 to be maintained in a pressurized state within the storage tank 140. According to some example embodiments, the storage tank 140 may include a regulator to regulate the flow of air or another substance into the storage tank 140. Further, the storage tank 140 may have a controllable output valve 142 that is fluidly coupled to the exit port 112 and is controllable to release a pressurized substance in the storage tank 140 when requested by, for example, the control circuitry 150. The output valve 142 may be controlled by the control circuitry 150 via an actuator in the form of, for example, a solenoid or a high speed servo configured to control the output of the substance via the valve 142.

According to some example embodiments, the drill 100 may further include a reservoir 141. The reservoir 141 may be mounted on the drill chassis 105 and may be fluidly coupled to the storage tank 140 and the pump 130. The reservoir 141 may be configured to hold a lubricant and may include a pulse lubricator. In this regard, during operation, the lubricant in the reservoir 141 may be mixed with, for example, the pressurized air in the storage tank 140 and form a substance as a mist that may be controllably output via the exit port 112. According to some example embodiments, the lubricant may be an oil-based coolant or cutting fluid. The inclusion of the lubricant in the substance that is output via the exit port 112 may operate to in increase the cooling capabilities of the drill 100 (e.g., the working bit 111 may be cooled faster). The working bit 111 may experience increased cooling with the lubricant included in the output substance (relative to the substance being only air) due to a reduction in the frictional forces and associated heating that occurs when a working bit 111 is cutting a hole. According to some example embodiments, the reservoir 141 may be implemented without a storage tank 140 and the pump 130 may be configured to output a mixture of, for example, pressurized air with a lubricant directly (i.e., without utilizing a storage tank 140). Thus, according to some example embodiments, the pump 130 and/or the storage tank 140 and the reservoir 141 may form a lubrication system of the drill 100.

According to some example embodiments, the drill 100 may further include a battery 160. The battery 160 may, for example, be a lithium-ion rechargeable battery. The battery 160 may be, according to some example embodiments, a rechargeable battery that is removable from the drill 100 and the drill chassis 105, and may be replaceable. In this regard, the drill 100 may include a cavity for receiving the battery 160 and locking the battery 160 into place such that the electrical contacts of the battery 160 are electrically coupled with the electrical contacts of the drill 100. In this regard, the battery 160 may be removable from the cavity to be installed in a charger. Alternatively, according to some example embodiments, the battery 160 may be permanently mounted to the drill chassis 105 and may be rechargeable by connecting the drill 100 to an electrical power source that would operate to charge the battery 160. When charged, the battery 160 may be configured to provide electrical power to the electrical components of the drill 100, including the motor 120, the pump 130, and the control circuitry 150. According to some example embodiments, the battery 160′s electrical power may also be provided to the reservoir 141 or the storage tank 140.

Further, according to some example embodiments, the drill 100 may include control circuitry 150. The control circuitry 150 may be configured to receive inputs from a control interface 151 and cause, for example, the motor 120 or the pump 130 to operate based on those inputs. According to some example embodiments, the drill 100 may include a control interface 151, which may include user interface controls that a user may be utilized to provide input signals to the control circuitry 150.

The control circuitry 150 may include a processing device, which may be, for example, a controller, microcontroller, microprocessor, field programmable logic array (FPGA), application specific integrated circuit (ASIC), or the like configured to control the operation of the drill 100 as described herein. In this regard, the control circuitry 150 may be structurally configured to perform these functionalities. In some example embodiments where the control circuitry 150 includes programmable capabilities, at least some components of the control circuitry 150 may be configured via firmware or other instruction sets that are retrieved from a memory device of the control circuitry 150 and executed by a processing device of the control circuitry 150. In some example embodiments, the processing device may be configured via hardware design or one-time, irreversible programming to be configured to perform the functionalities of the control circuitry 150 described herein.

Accordingly, the control circuitry 150 may be configured to receive input signals from the control interface 151 and operate the drill 100 accordingly. The control interface 151 may be any type of user interface which may include, for example, a control switch or lever that is positioned, for example, as a trigger or lever on a handle of the drill 100. In this regard, the control switch may provide a variable signal based on how far the control switch is depressed. Accordingly, the control switch may provide a variable signal to the control circuitry 150 that can be interpreted to cause the motor 120 to operate at variable speed based on the signal provided by the control switch. Further, according to some example embodiments, the control interface 151 may also include a reversing switch that, when operated, provides a signal to the control circuitry 150 to change the direction of the rotation for the motor 120 and thus the spindle 110 and working bit 111.

According to some example embodiments, the control interface 151 may also include a control for manually operating the output valve 142. In this regard, for example, as the control switch for controlling the motor 120 is depressed, the valve 142 may be manually or electrically opened to permit the substance in the storage tank 140 to the output to the exit port 112.

According to some example embodiments, the control circuitry 150 may include wireless communications capabilities. In this regard, the control circuitry 150 may include an antenna and a radio configured to support the sending and receiving of wireless communications. In this regard, in an embodiment where the drill 100 has an option to be connected to an external source for the compressed substance, the wireless communications functionalities of the control circuitry 150 may be leveraged to control the operation of the remote pump or compressor and valves for a remote storage tank. According to some example embodiments, the wireless communications capabilities of the control circuitry 150 may also be leveraged to communicate diagnostic and operational information about the drill 100 to, for example, a centralized server that may monitor operation statistics for maintenance, end of life, and other purposes.

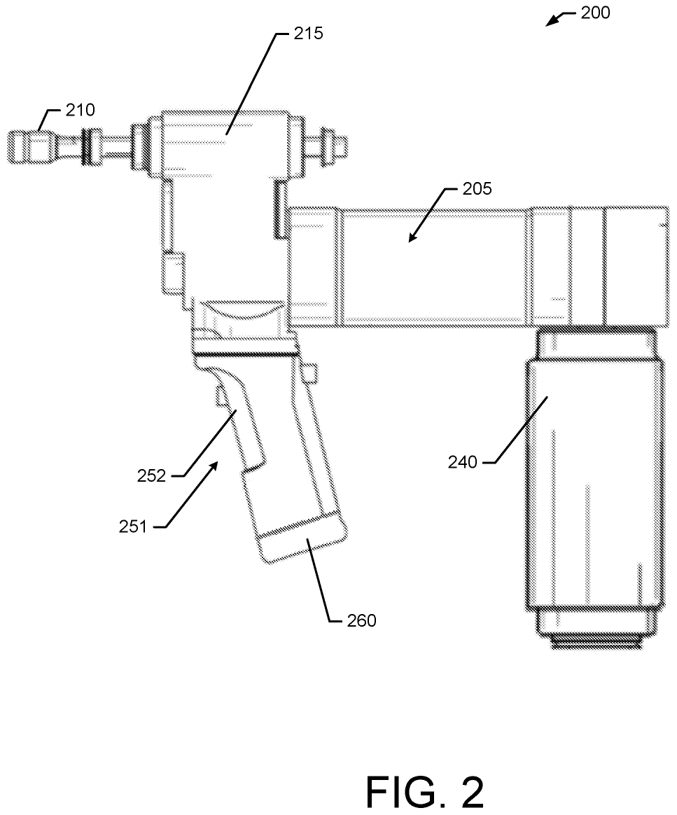

According to some example embodiments, another example drill 200 is illustrated in FIG. 2. Similar to the drill 100, the drill 200 may be completely self-contained and portable to avoid the need to attach a hose or other tether the drill 200. The drill 200 may be similar to the drill 100, however, with a different architecture for the components. With reference to certain elements, the drill 200 may include a spindle 210 that is configured to operate in the same or similar manner as the spindle 110. Further, the drill 200 may include a positive feed drill head 215 which may operate in the same or similar manner as the positive feed drill head 115 and include both engage feed and retract feed mechanisms. Further, the drill 200 may be structurally formed on a drill chassis 205, which may be disposed internal to, for example, an external housing of the drill 200. As described with respect to the drill 100, according to some example embodiments, the various components of the drill 200 may be mounted on the drill chassis 205.

Further, drill 200 may include a control interface 251 that may be disposed on the handle of the drill 200 such that control switch 252 of the control interface 251 may be used to control the operation of the drill 200 by sending a control signal to control circuitry 150 disposed within the drill 200. Further, at the end of the handle, a replaceable and rechargeable battery 260 may be installed to power the drill 200, similar to the manner in which battery 160 powers the components of the drill 100.

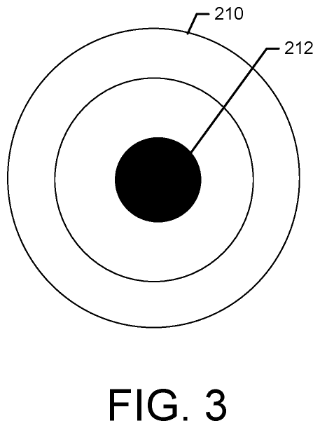

Drill 200 may also include a storage tank 240 that may be fluidly coupled to an internal pump that is configured to force a substance (e.g., air) into the storage tank 240 in a pressurized state. In this regard, the storage tank 240 may be the same or similar to the storage tank 140. The storage tank 240 may also be fluidly coupled to an exit port 212 in the spindle 210. In this regard, FIG. 3 shows a front view of the spindle 210 with the exit port 212 being centrally located. According to some example embodiments, the storage tank 240 may also be coupled to a lubricant reservoir to facilitate forming a mixture that may be output as a mist from the exit port 212.

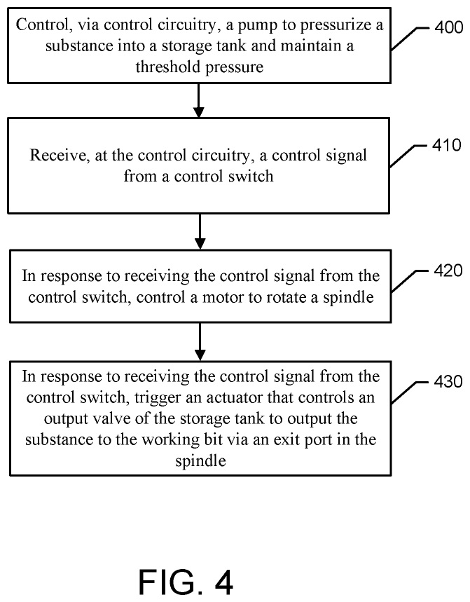

FIG. 4 illustrates a flow chart that describes some example operations that may be performed by, for example, the control circuitry 150 of the drill 100 in accordance with various example embodiments. In this regard, as described above, a processing device and other hardware components of the control circuitry 150 may be configured to perform the operations described with respect to FIG. 4.

The control circuitry 150 may be configured to control a pump (e.g., pump 130) to pressurize a substance (e.g., air or a mixture of air and lubricant) into a storage tank (e.g., storage tank 140) and further cause the pump to maintain a threshold pressure in the storage tank at 400. In this regard, the control circuitry 150 may be configured to monitor a pressure within the storage tank 140 and trigger operation of the pump to force additional substance into the storage tank if the pressure within the storage tank falls below a threshold amount. As such, the control circuitry 150 may be configured to continuously monitor and maintain the pressure within the storage tank. According to some example embodiments, two pressure thresholds may be monitored (i.e., a start pressure threshold and a stop pressure threshold) to avoid hysteresis. The start pressure threshold may be lower than the stop pressure threshold. As such, the control circuitry 150 may be configured to operate the pump to increase the pressure in the storage tank in response to the pressure in the storage tank falling below the start pressure threshold. The control circuitry 150 may be further configured to continue to increase the pressure in the storage tank until the pressure in the storage tank exceeds the stop pressure threshold.

Further, according to some example embodiments, a lubricant from a reservoir (e.g., reservoir 141) may be included in the substance to form a mixture (e.g., air and lubricant) within the storage tank. In this regard, the control circuitry 150 may also control the introduction of the lubricant to the storage tank by sending control signals to a pulse lubrication system.

Further, at 410, the control circuitry 150 may be configured to receive a control signal from a control switch. In this regard, the control switch may be a component of a control interface (e.g., control interface 151). The control signal may be an indication that the control switch has been depressed by a user. The control signal may be a binary/digital signal or the signal may have variable levels based on the deflection of the control switch.

At 420, in response to receiving the control signal, the control circuitry 150 may be configured to control a motor (e.g., motor 120) to rotate a spindle (e.g., spindle 110) of a drill. In this regard, the control circuitry 150 may be configured to control the speed of the motor based on the control signal, and thus the spindle, and a working bit disposed in the spindle may be rotated due to being mechanically coupled to the motor.

Also, in response to receiving the control signal, the control circuitry 150 may be configured to trigger an actuator that controls an output valve (e.g., valve 142) of the storage tank to output the substance to the working bit via an exit port in the spindle, at 430. In this regard, the control circuitry 150 may be configured to control the actuator, which may be a solenoid or a high speed servo. In this this regard, based on the control signal, the valve may be opened to permit the pressurized substance to be released into, for example, tubing that leads from the storage tank to the exit port in the spindle. The pressurized substance, which may be, for example, a mixture of air and lubricant, may be forced out of the exit port and through a working bit that has a working bit exit port at the forward, working end of the working bit. As the pressurized substance is output into, for example, the hole being cut by the working bit in the workpiece, the substance may cool and lubricate the working bit and also blow out of any debris formed by the drill operation including drill chips.

Many modifications and other embodiments in addition to those set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A cordless portable power drill comprising:
a drill chassis;
a spindle mounted to the drill chassis, the spindle configured to drive a working bit;
an exit port configured to direct a flow of a substance towards the working bit;
an electric motor mounted to the drill chassis and operably configured to rotate the spindle; and
a pump mounted to the drill chassis, the pump being fluidly coupled to the exit port, wherein the pump is configured to pressurize the substance for output via the exit port to cool the working bit or remove debris created by the working bit through interaction with a workpiece.

2. The cordless power drill of claim 1 further comprising a battery configured to power the electric motor.

3. The cordless power drill of claim 1 wherein the pump comprises an air compressor.

4. The cordless power drill of claim 1 wherein the pump comprises a piezoelectric pump.

5. The cordless power drill of claim 1 further comprising a storage tank fluidly coupled to the pump and the exit port, the storage tank being configured to retain at least a component of the substance in a pressurized state;
wherein the pump is further configured to force the at least a component of the substance into the storage tank to pressurize the at least a component of the substance.

6. The cordless power drill of claim 5, wherein the storage tank is mounted to the drill chassis.

7. The cordless power drill of claim 1 further comprising a positive feed drill head mounted to the drill chassis and operably coupled to the spindle.

8. The cordless power drill of claim 7 wherein the positive feed drill head includes a plurality of reduction gears that operably couple to the spindle to cause translational movement of the spindle along a center of rotation of the spindle.

9. The cordless power drill of claim 7 wherein the positive feed drill head comprises an engage feed mechanism configured to translate the spindle in a forward direction towards the workpiece and a retract feed mechanism configured to translate the spindle in a rearward direction away from the workpiece.

10. The cordless power drill of claim 1 further comprising a lubricant reservoir holding a lubricant, the lubricant reservoir being fluidly coupled to the pump such that the substance forced through the exit port comprises the lubricant.

11. The cordless power drill of claim 10 wherein the lubricant is an oil-based coolant.

12. The cordless power drill of claim 1 wherein the exit port is disposed on a rotating fitting on the drill spindle.

13. The cordless power drill of claim 1 further comprising a microcontroller configured to control the electric motor and the pump.

14. A cordless portable power drill comprising:
a drill chassis;
a spindle mounted to the drill chassis, the spindle configured to drive a working bit;
an electric motor mounted to the drill chassis and operably configured to rotate the spindle;
a battery configured to power the electric motor;
an air compressor mounted to the drill chassis, the air compressor being powered by the battery; and
a storage tank fluidly coupled to the air compressor and an exit port, the storage tank being configured to retain air in a pressurized state;
wherein the air compressor is configured to pressurize air into the storage tank for controlled output via the exit port to cool the working bit or remove debris created by the working bit through interaction with a workpiece.

15. The cordless power drill of claim 14 further comprising a positive feed drill head mounted to the drill chassis and operably coupled to the spindle.

16. The cordless power drill of claim 15 wherein the positive feed drill head includes a plurality of reduction gears that operably couple to the spindle to cause translational movement of the spindle along a center of rotation of the spindle.

17. The cordless power drill of claim 15 wherein the positive feed drill head comprises an engage feed mechanism configured to translate the spindle in a forward direction towards the workpiece and a retract feed mechanism configured to translate the spindle in a rearward direction away from the workpiece.

18. The cordless power drill of claim 14 further comprising a lubricant reservoir holding a lubricant, the lubrication reservoir being fluidly coupled to the storage tank, wherein the storage tank and the lubricant reservoir are configured to output the compressed air with the lubricant through the exit port.

19. The cordless power drill of claim 18 wherein the lubricant is an oil-based coolant.

20. The cordless power drill of claim 1 wherein the exit port is disposed on a rotating fitting on the drill spindle.
